(19) United States
(12) Patent Application Publication
(10) Pub. No.: US 2017/0180455 A1
(43) Pub. Date: Jun. 22, 2017

(54) DELEGATION OF DETAILED CONTENT AND APP REVIEWS BETWEEN NEARBY DEVICES

(71) Applicant: Google Inc., Mountain View, CA (US)

(72) Inventors: Andrew Abramson, Sunnyvale, CA (US); Benjamin David Poiesz, Santa Clara, CA (US)

(21) Appl. No.: 14/979,178

(22) Filed: Dec. 22, 2015

(51) Int. Cl. H04L 29/08; G06F 3/0484; H04W 4/02; G06Q 30/02; H04W 4/00

(52) U.S. Cl. CPC H04L 67/06; G06Q 30/0282; H04W 4/005; H04W 4/021; G06F 3/0484

(57) ABSTRACT

A method is provided for allowing a user to write and submit a review of an application. The method comprises receiving, from a first computing device, a request to write a review of an application, detecting whether one or more second computing devices are in the vicinity of the first computing device, determining whether the first computing device or one of the one or more second computing devices is to be used to write the review, and initiating a rating user-interface (UI) to be displayed over the determined computing device, and receiving from the determined computing device the written review.

### BACKGROUND

The present subject matter relates to execution of software applications on multiple devices. More specifically, the present subject matter relates to the rating of software applications executed on different form factors.

Providing detailed reviews is difficult when using certain form factors of computing devices. For example, televisions (TVs), wearables, and automobiles may be non-ideal form factors to enter long form reviews, but are important to provide feedback on because the experiences among form factors can be vastly different.

Also, applications (apps) are now commonly developed exclusively for one of these types of form factors, wherein it is then only possible to enter reviews manually through a desktop computer by looking up the app and writing a review. This results in very few reviews.

In cases where the app is also available on phones and/or tablets, reviews are much more plentiful, however they are focused primarily on the phone/tablet experience since that is the only place a user can write such a review.

### BRIEF SUMMARY

According to an embodiment of the disclosed subject matter, a method comprises receiving, from a first computing device, a request to write a review of an application, detecting whether one or more second computing devices are in the vicinity of the first computing device, determining whether the first computing device or one of the one or more second computing devices is to be used to write the review, initiating a rating user-interface (UI) to be displayed over the determined computing device, and receiving from the determined computing device the written review.

In an embodiment, the determining comprises receiving from the first computing device a selected one of the one or more second computing devices to be used to write the review.

In an embodiment, the first computing device is a television.

In an embodiment, the one or more second computing devices is at least one of a smartphone, a tablet, and a laptop.

In an embodiment, the method further comprises transmitting to the selected second computing device the rating UI, and transmitting for display over the first computing device, the written review received from the selected second computing device.

In an embodiment, the determining comprises receiving from the first computing device a selection of the first computing device to be used to write the review.

In an embodiment, the method further comprises determining device information for the first computing device, and storing the determined device information with the received written review.

In an embodiment, the device information includes at least a device type.

In an embodiment, the method further comprises transmitting to each of the one or more second computing devices and the first computing device the rating UI, detecting the receipt of the written review from one of the one or more second computing devices and first computing device, removing the rating UI from each of the one or more second computing devices and the first computing device that did not submit the written review.

According to an embodiment of the disclosed subject matter, a system comprises an application distribution server configured to receive, from a first computing device, a request to write a review of an application, detect whether one or more second computing devices are in the vicinity of the first computing device, determine whether the first computing device or one of the one or more second computing devices is to be used to write the review, initiate a rating user-interface (UI) to be displayed over the determined computing device, and receive from the determined computing device the written review.

According to an embodiment of the disclosed subject matter, means for receiving, from a first computing device, a request to write a review of an application, detecting whether one or more second computing devices are in the vicinity of the first computing device, determining whether the first computing device or one of the one or more second computing devices is to be used to write the review, and initiating a rating user-interface (UI) to be displayed over the determined computing device, and receiving from the determined computing device the written review are provided.

Additional features, advantages, and embodiments of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example system configuration according to an embodiment of the disclosed subject matter;

FIG. 2 shows a computing device according to an embodiment of the disclosed subject matter;

FIG. 3 shows an example illustration of the system according to an embodiment of the disclosed subject matter;

FIG. 4 shows an example illustration of a user-interface according to an embodiment of the disclosed subject matter;

FIG. 5 shows an example illustration of a rating user-interface according to an embodiment of the disclosed subject matter;

FIG. 6 shows an example illustration of a user-interface including detected computing devices according to an embodiment of the disclosed subject matter;

FIG. 7 shows an example flow diagram of a method according to an embodiment of the disclosed subject matter; and

FIG. 8 shows an example rating user-interface displayed on a detected computing device according to an embodiment of the disclosed subject matter.

### DETAILED DESCRIPTION

The present subject matter discloses a system and method for enabling a user to provide feedback for a software application executed over a computing device having a form factor that is not necessarily well suited for providing feedback (for example a television (TV)), using another computing device that is detected in the vicinity. A user may initiate a rating of the software application on the TV through a rating user interface (UI). A determination is made as to whether another device is in the vicinity of the TV. The user may then be provided with the option of using the TV remote to input a review in the rating UI or to input the review using the detected device. For example, a user may be using an electronic mail app, e.g., GMAIL® on a TV, for example through Android TV™. When the user finishes using the app, the user may be prompted to, or request to, rate the GMAIL® app on the TV. If the user agrees to review the app, a determination is made as to whether a smartphone, tablet, laptop, computer, etc., belonging to the user is in the vicinity of the TV. In this example, the user's smartphone is detected in the vicinity. Once the smartphone is detected, a message is output on the TV asking the user if he/she would like to use the detected smartphone to input the review. The user may then elect to enter the review via the smartphone. A message may then be sent to the user's smartphone requesting the user to enter the review for GMAIL®. Once the user enters the review, the review is submitted for viewing by others and displayed on the TV.

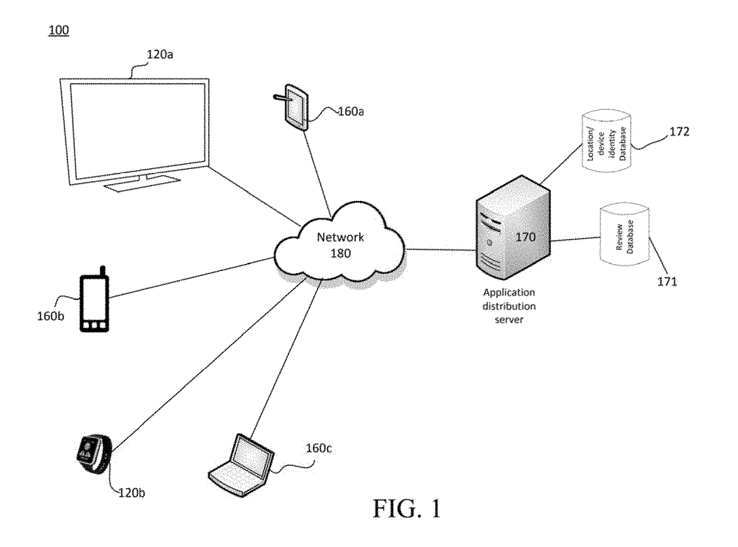

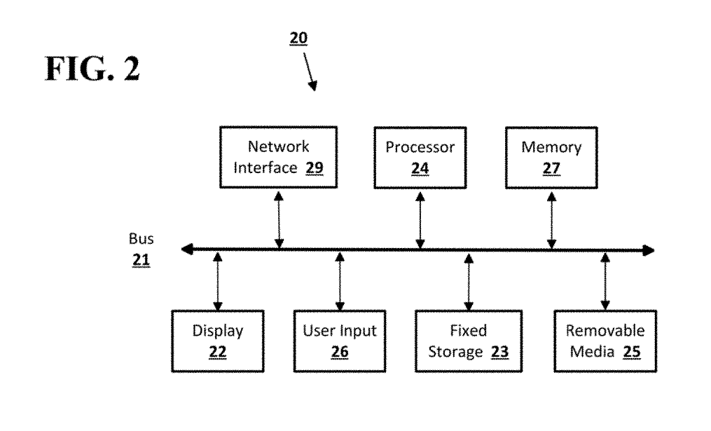

FIG. 1 illustrates an exemplary system 100 for providing feedback from a user of a software application (app) over a computing device 120a, 120b having limited review/rating input capability, for example a television (TV), wearables, or the like. Computing devices 120a . . . 120b and 160a . . . 160c each may communicate through network 180 with an application distribution server 170. An example computing device 120a . . . 120b and 160a . . . 160c suitable for implementing embodiments of the presently disclosed subject matter is illustrated in FIG. 2.

Referring to FIG. 2, the computing device 20 may be, for example, a smart TV, a desktop or laptop computer, a mobile computing device such as a smart phone, tablet, or the like, or a wearable such as a smartwatch, Google Glass®, or the like. The device 20 may include a bus 21 which interconnects major components of the computer 20, such as a central processor 24, a memory 27 such as Random Access Memory (RAM), Read Only Memory (ROM), flash RAM, or the like, a user display 22 such as a display screen, a user input interface 26, which may include one or more controllers and associated user input devices such as a keyboard, mouse, touch screen, and the like, a fixed storage 23 such as a hard drive, flash storage, and the like, a removable media component 25 operative to control and receive an optical disk, flash drive, and the like, and a network interface 29 operable to communicate with one or more remote devices via a suitable network connection.

The bus 21 allows data communication between the central processor 24 and one or more memory components, which may include RAM, ROM, and other memory, as previously noted. Typically RAM is the main memory into which an operating system and application programs are loaded. A ROM or flash memory component can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium.

The fixed storage 23 may be integral with the computer 20 or may be separate and accessed through other interfaces. The network interface 29 may provide a direct connection to a remote server via a wired or wireless connection. The network interface 29 may provide such connection using any suitable technique and protocol as will be readily understood by one of skill in the art, including digital cellular telephone, WiFi, Bluetooth®, near-field, and the like. For example, the network interface 29 may allow the computer to communicate with other computers via one or more local, wide-area, or other communication networks, as described in further detail below.

Many other devices or components (not shown) may be connected in a similar manner (e.g., document scanners, digital cameras and so on). Conversely, all of the components shown in FIG. 2 need not be present to practice the present disclosure. The components can be interconnected in different ways from that shown. The operation of a computer such as that shown in FIG. 2 is readily known in the art and is not discussed in detail in this application. Code to implement the present disclosure can be stored in computer-readable storage media such as one or more of the memory 27, fixed storage 23, removable media 25, or on a remote storage location.

Referring back to FIG. 1, the computing devices 120 and 160, upon executing an application, may provide the application server 170 with ratings feedback relating to the user's experience using the application. In an implementation of the present subject matter, the ratings feedback may be a review of the application over the medium in which it was executed. For example, a user may rate how the application performs on a certain form factor, for example, the user's experience of a mobile app executed and/or displayed on a TV. The application server 170 may be a digital distribution platform for application software. In an implementation of the present subject matter, the application server 170 may store received ratings feedback in memory included in the server or in a review database 171. The application server 170 comprises one or more processors for executing instructions stored in memory (not shown). The ratings database 171 may be coupled to the application server 170. A location/device identity database 172 may also be coupled to the application server 170. The location/device identity database 172 may be configured to store identities of devices within the vicinity of a certain area, to be disclosed below.

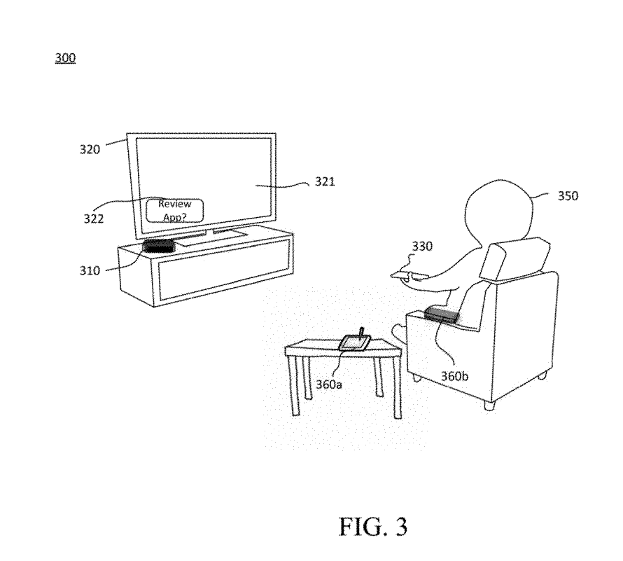

An example of an implementation of the ratings feedback system 300 in use by a user 350 is illustrated in FIG. 3. A computing device 320, e.g., a television (TV), is configured to execute an application, and may comprise a display 321 to display a user interface (UI) of the application. Using the example set forth above, the UI may be for GMAIL®. In an implementation, the user 350 may interact with the TV 320 and UI using a remote control 330. The remote control 330 may be a remote associated with the TV 320, e.g., a remote for an Android TV™, or a remote associated with a receiver 310 that is coupled to the TV 320, e.g., Google® TV, Chromecast™, etc.

In an implementation, the receiver 310 may provide the platform that runs the necessary operating system, e.g., iOS, Android, etc., to create an interactive television experience similar to the user's 350 experience on a smartphone, tablet, or the like. The receiver 310, although illustrated as a separate component, may be integrated into a smart TV, such as included in an Android TV™. The receiver 310 may also be a dongle that is plugged into a USB port on the TV 320, for example, Chromecast™.

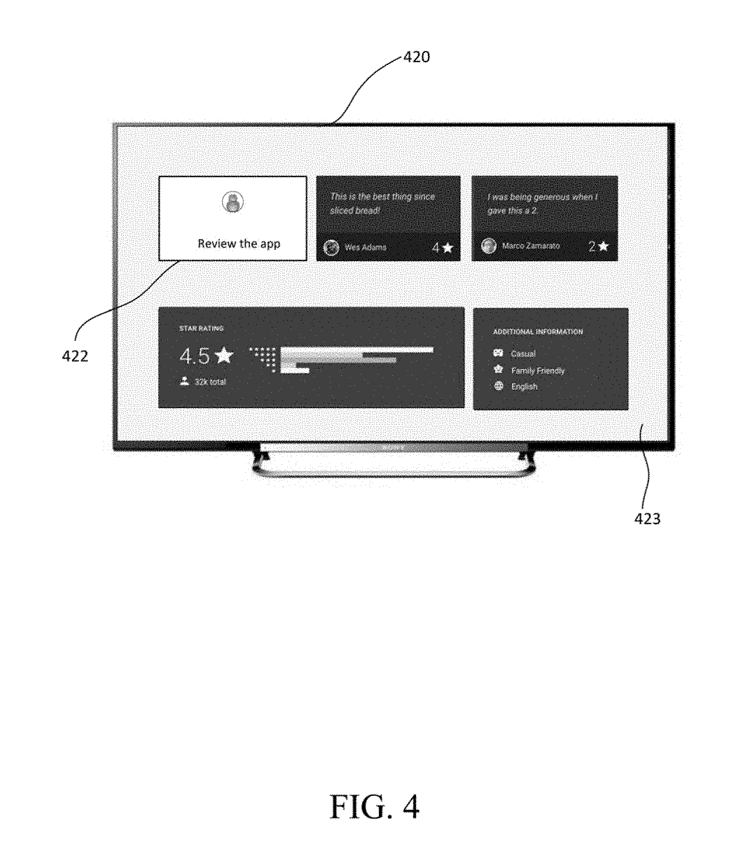

In an implementation, when an application is selected by the user 350, a ratings icon 322 may be displayed in the UI that, when activated, initiates a UI that allows the user 350 to select to review the user's 350 experience of the application over the TV 320. An example UI displaying the ratings icon is illustrated in FIG. 4. When the user finishes using an app, the TV displays the UI 423 that includes the ratings icon 422.

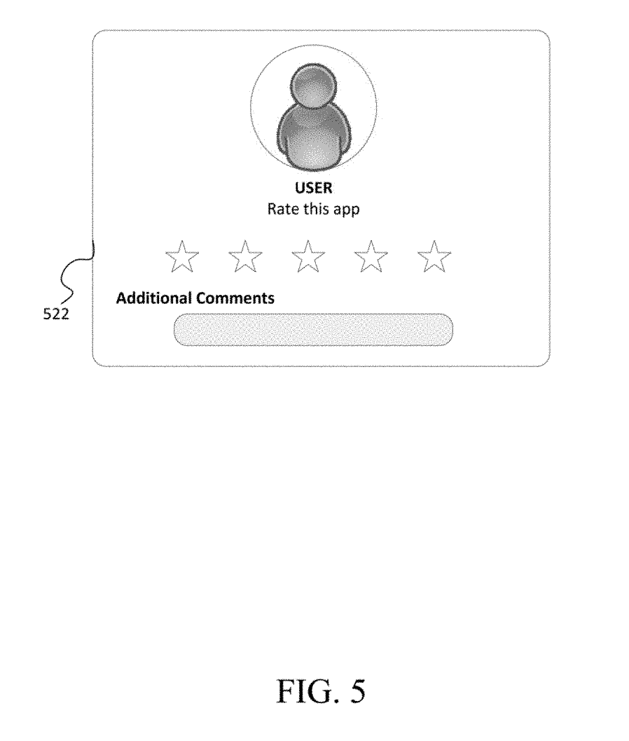

Referring back to FIG. 3, when the user selects the ratings icon 322, the application server is alerted that the user wishes to review the application and transmits information to generate the rating UI to the receiver 310 for display on the TV 320. The information used to render or generate the rating UI may include the user's account or identifier, and/or the application identifier (to be reviewed), for example. An example rating UI 522 is illustrated in FIG. 5.

In accordance with the present subject matter, the application server may also initiate the location and/or identity of other computing devices in the vicinity of the receiver 310/TV 320 to provide the user 350 with the option of entering the review using a device that includes a more conducive form factor for entering a review, for example, a smartphone, tablet, laptop, and/or the like.

Referring back to FIG. 1, the application server 170, coupled to the location database 172, determines the identity and location of any computing devices in the vicinity using the location database 172. In an implementation, the location database 172 stores the location of the user's devices that may also be logged into the application server 170. For example, the user may be logged into the application server via the user's smartphone, the user's tablet, and/or the user's laptop. When the user is logged into the application server 170, the user may access the applications stored therein. Location information for the computing device for which the user has logged into the application server is stored in the location database 172 and provided to the application server 170 when the rating UI has been initiated.

In an implementation, the application server 170 may request location information from each computing device 160a, 160b for which the user is logged into the application server 170 when a rating request has been initiated by the user. This information is stored in the location database 172 and used by the application server 170 to detect computing devices in the vicinity of the computing device requesting to provide a review.

In an implementation, the application server 170 may detect each computing device 160a, 160b based on the computing devices where the user is logged into an app store executed on the application server 170. For example, if the user is logged into the PLAY Store™, using the same account that the user is logged into on the TV, on the user's smartphone and/or tablet, the application server may transmit the information to generate the rating UI to the user's smartphone. Once the user accesses the app store via the user's smartphone, a rating UI is displayed on the user's smartphone.

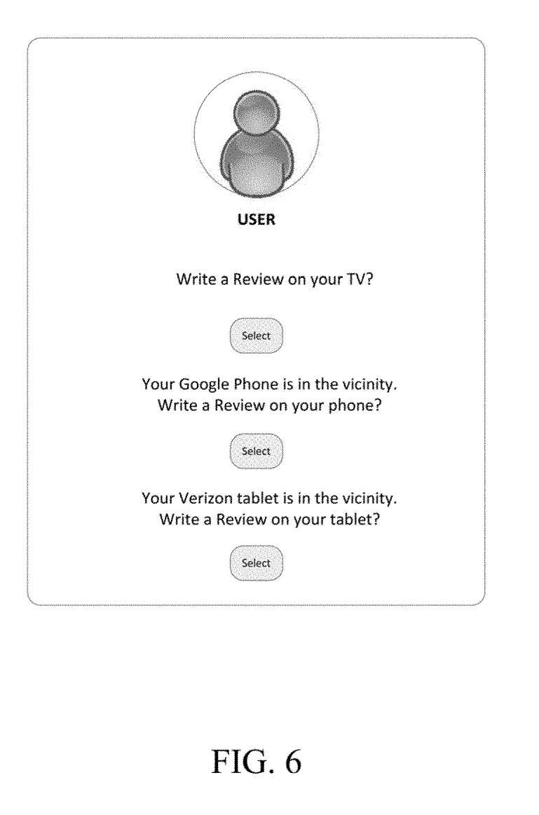

Referring back to FIG. 3, in an implementation, the application server detects the presence of other computing devices 360a, 360b in the vicinity of the TV 320. When other computing devices 360a, 360b are detected, the application server forwards a message to the user 350 via the UI displayed on the TV 320 to inform the user 350 that the user 350 may enter the review using one of the detected computing devices 360a, 360b. An example message displayed to the user when other computing devices are detected in the vicinity is illustrated in FIG. 6. As illustrated in FIG. 6, the application server may inform the user of the computing devices that have been detected and request the user to select the computing device that the user wishes to use to write the review, e.g., “Your Google® Phone is in the vicinity. Write a Review on your phone?” The user may elect to write the review using the TV or any one of the one or more detected computing devices. Whichever device the user selects, the user may write and submit the review to the application server using the selected device. The submitted review is stored in the review database by the application server and displayed over the UI of the TV.

In an implementation, the application server stores with the review certain computing device information relating to the device from which the application was executed. In the example illustrated in FIG. 3, the computing device information may relate to the TV 320. The computing device information may include a device type, e.g., TV, smartphone, tablet, or the like. Other information, for example, brand or model number, related to the computing device may be stored as well with the submitted review.

In an implementation, when another user seeks to review the ratings of the application, the application server may provide the ratings that are related to the type of computing device for which the other user is requesting this information. The application server may provide the ratings sorted by the computing device for which the ratings relate. For example, a user may request the ratings for an application that the user wants to use on a TV. The application server may display to the user only those reviews that relate to the application's use on a TV, and/or display all of the reviews for the application sorted by computing device, e.g., ratings for smartphone use would be grouped together, ratings for TV use would be grouped together, etc.

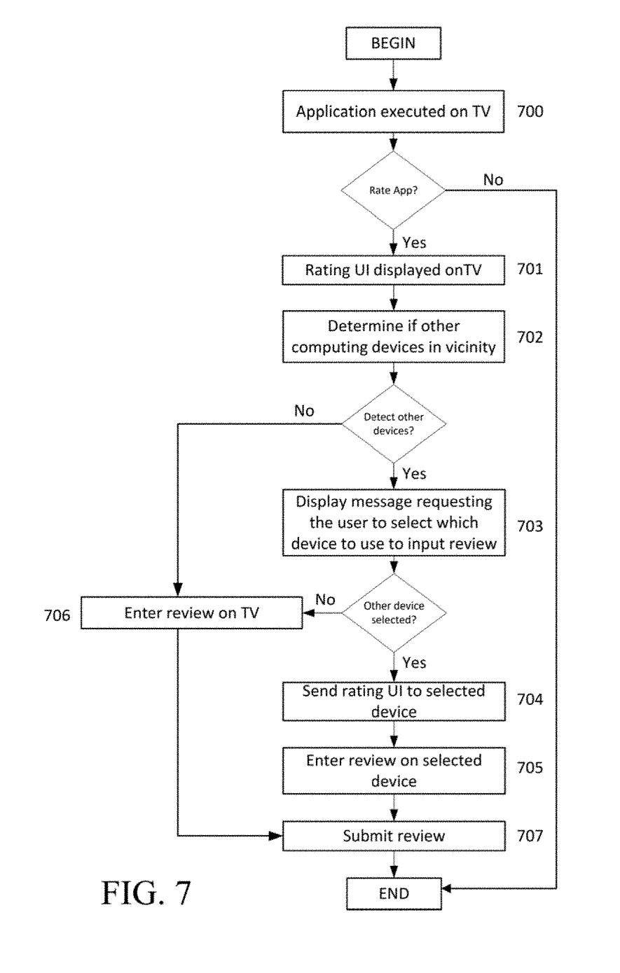

An example flow diagram of an implementation of the system is illustrated in FIG. 7. A user may select an application for execution in an ecosystem that may be different from the user's smartphone, tablet, and/or computer ecosystem, for example, a TV ecosystem, a wearable ecosystem, etc. For example, the user may be executing the app on a TV (700). The application may be any application wherein the user may interact with the application via a UI displayed on the TV. The user interacts with the TV via a remote control that may be associated with the TV or a receiver. During execution of the app on the TV the user may request to rate the user's experience of the app on the TV, or a notification may be displayed to the user via the UI inquiring if the user would like to rate/review the app. If the user would like to submit a review of the app, a rating UI may be displayed to the user on the TV (701).

In an implementation, the rating UI may be initiated via the application server that the user may be logged into via the TV. For example, the user may be logged into Google Play™, Apple's® AppStore, or other App store. When the rating UI is initiated by the user, a determination is made as to whether there are any other computing devices in the vicinity of the user. (702). For example, the user may be logged into the application server on multiple devices, such as the user's smartphone, tablet, laptop, and/or desktop. For those devices where the user is logged in, the location of the determined devices may be known or determined. As such, the location of the other computing devices may be compared to the location of the device executing the app to be reviewed.

If another computing device, for example the user's smartphone and/or tablet, is/are determined to be within a predetermined area, i.e., the vicinity of the TV, a message is displayed over the UI of the TV that inquires as to whether the user would like to complete the review of the app using one of the detected computing devices that are determined to be within the vicinity of the TV. (703). The predetermined area may be an area around the TV that is within the range of Bluetooth®, a certain distance from the TV determined by the user, and/or a predetermined distance from the TV, allowing the user to quickly access the detected computing device.

As disclosed above, in an implementation, the application server may detect that the user is logged into the app store that the TV is logged into on another computing device. The detected computing devices may then be those computing devices for which the user is logged into the app store.

If the user elects not to use one of the detected computing devices in the vicinity, the user may input the review in the rating UI using the remote, (706), and submit the review to the application server, which stores the review and displays the review on the TV. (707).

In an implementation, the user may select the number of stars for the rating of the app, e.g., 4 stars, on the TV using a D-pad or remote, for example, and then “Additional Comments” or review text may be presented for input to the user in the UI on a detected computing device.

If the user elects to use one of the detected computing devices in the vicinity, the user selects the computing device. The rating UI is then sent to the selected device (704), wherein the rating UI is presented to the user on the selected device so that the user may enter the review. (705). Once the user enters the review, the user may submit the review to the application server, and the review is displayed on the TV. (707).

In an implementation, the receiver and/or computing device that is executing the app may detect whether another computing device is in the vicinity for inputting a review using location services, for example devices connected to the receiver, TV, smartwatch, etc. via a wired connection and/or a wireless connection, e.g., via Bluetooth®, Samsung® account, or iTunes® account. The receiver and/or computing device may also use technologies, such as Nearby, to detect another device proximate thereto.

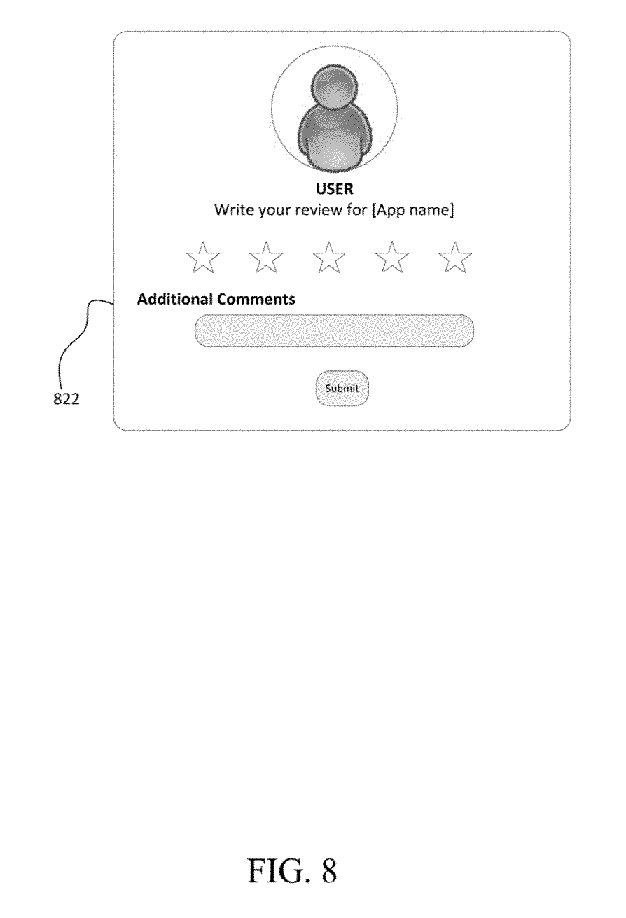

In an implementation, any detected computing device within the vicinity may be automatically sent the rating UI indicating the ability of the user to write a review for the app on the respective computing device. An example rating UI that is sent to each detected computing device is illustrated in FIG. 8. When the detected computing device receives the rating UI, the user may enter and submit the review. The submitted review is then displayed on the computing device where the application has been executed. As implemented, once one of the detected computing devices submits a review for the app, the rating notification displayed on the other detected computing devices is removed.

In an implementation, the use may select the rating icon in the app. the UI on the TV then may indicated to the user to open the app store, e.g., PLAY Store, on the user's smartphone, tablet, or laptop. Once the user opens the app store on the user's smartphone, tablet, or laptop, the rating UI, e.g., the UI as illustrated in FIG. 8, is displayed on the device which accessed the app store.

The implementation of the disclosed subject matter allows a user to write a detailed review of the user's experience with an application executed on a computing device having a less than ideal form factor for entering such a review by writing and submitting the review on a computing device that is detected in the vicinity of the user.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a system as disclosed herein.

Various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method comprising:
receiving, from a first computing device, a request to write a review of an application;
detecting whether one or more second computing devices are in the vicinity of the first computing device;
determining whether the first computing device or one of the one or more second computing devices is to be used to write the review;
initiating a rating user-interface (UI) to be displayed over the determined computing device; and
receiving from the determined computing device a written review.

2. The method of claim 1, wherein the determining comprises receiving from the first computing device an identity of a selected one of the one or more second computing devices to be used to write the review.

3. The method of claim 2, wherein the first computing device is a television.

4. The method of claim 3, wherein the one or more second computing devices is at least one of a smartphone, a tablet, and a laptop.

5. The method of claim 2, further comprising:
transmitting to the selected second computing device the rating UI; and
transmitting for display over the first computing device, the written review received from the selected second computing device.

6. The method of claim 1, wherein the determining comprises receiving from the first computing device a selection of the first computing device to be used to write the review.

7. The method of claim 2, further comprising:
determining device information for the first computing device; and
storing the determined device information with the received written review.

8. The method of claim 7, wherein the device information includes at least a device type.

9. The method of claim 1, further comprising:
transmitting to each of the one or more second computing devices and the first computing device the rating UI;
detecting the receipt of the written review from one of the one or more second computing devices and first computing device; and
removing the rating UI from each of the one or more second computing devices and the first computing device that did not submit the written review.

10. A system comprising:
an application distribution server configured to:
receive, from a first computing device, a request to write a review of an application;
detect whether one or more second computing devices are in the vicinity of the first computing device;
determine whether the first computing device or one of the one or more second computing devices is to be used to write the review;
initiate a rating user-interface (UI) to be displayed over the determined computing device; and
receive from the determined computing device the written review.

11. The system of claim 10, wherein the determining by the application distribution server comprises receiving from the first computing device a selected one of the one or more second computing devices to be used to write the review.

12. The system of claim 11, wherein the first computing device is a television.

13. The system of claim 12, wherein the one or more second computing devices is at least one of a smartphone, a tablet, and a laptop.

14. The system of claim 11, wherein the application distribution server is further configured to:
transmit to the selected second computing device the rating UI; and
transmit for display over the first computing device, the written review received from the selected second computing device.

15. The system of claim 10, wherein the application distribution server is further configured to receive from the first computing device a selection of the first computing device to be used to write the review to determine whether the first computing device or one of the one or more second computing devices is to be used to write the review.

16. The system of claim 11, wherein the application distribution server is further configured to:
determine device information for the first computing device; and
store the determined device information with the received written review.

17. The system of claim 16, wherein the device information includes at least a device type.

18. The system of claim 10, wherein the application distribution server is further configured to:
transmit to each of the one or more second computing devices and the first computing device the rating UI;
detect the receipt of the written review from one of the one or more second computing devices and first computing device; and
remove the rating UI from each of the one or more second computing devices and the first computing device that did not submit the written review.
